(19) United States
(12) Patent Application Publication
(10) Pub. No.: US 2011/0253696 A1
(43) Pub. Date: Oct. 20, 2011

(54) Ceramic Heating Device

(76) Inventors: Michael J. Hanagan, Rutland, MA (US); Thomas Sheridan, Oakham, MA (US); Craig Willkens, Fort Wayne, IN (US)

(21) Appl. No.: 13/050,775

(22) Filed: Mar. 17, 2011

Related U.S. Application Data
(60) Provisional application No. 61/314,807, filed on Mar. 17, 2010.

(51) Int. Cl. F23Q 7/22; B23P 19/04

(52) U.S. Cl. 219/260; 29/592.1

(57) ABSTRACT

New ceramic resistive igniter elements are provided that comprise one or more portions provided with one or more surface patterns to thereby modify the electrical pathway and, further, modify the resistance in the one or more portions. New methods for fabricating resistive igniter elements are also provided wherein one or more surface patterns are provided, for example post densification, wherein the surface pattern(s) modify the electrical pathway through the elements as compared with the electrical pathway prior to disposition of the surface pattern(s). In particular, one or more interruptions are provided in the electrical pathway of an element such that the electrical pathway is modified and, further the resistance through the element is modified.

This application claims the benefit of U.S. provisional application No. 61/314,807 filed Mar. 17, 2010, which is incorporated herein by reference in its entirety.

### BACKGROUND

1. Field of the Invention

The present invention relates to ceramic heating devices, such as igniters and glow plugs, and more particularly to such devices having a portion in which a the electrical pathway through that portion is increased by providing a surface pattern on or within that portion. In particular, the surface pattern provides one or more interruptions in the electrical pathway such that an increased electrical pathway is defined around the one or more interruptions. Such an increased electrical pathway can provide an increased resistivity in the igniters. The invention also relates to methods for manufacture of ceramic heating elements. In particular, methods are provided for increasing the electrical pathway through at last a portion of the heating element and/or increasing the resistivity through at last a portion of the heating element.

2. Background

Ceramic materials have enjoyed great success as igniters in e.g. gas-fired furnaces, stoves and clothes dryers. Ceramic igniter production includes constructing an electrical circuit through a ceramic component a portion of which is highly resistive and rises in temperature when electrified by a wire lead. See, for instance, U.S. Pat. Nos. 6,028,292; 5,801,361; 5,405,237; and 5,191,508.

Typical igniters have been generally rectangular-shaped elements with a highly resistive “hot zone” at the igniter tip with one or more conductive “cold zones” providing to the hot zone from the opposing igniter end. One currently available igniter, the Mini-Igniter™, available from Norton Igniter Products of Milford, N. H., is designed for 12 volt through 120 volt applications and has a composition comprising aluminum nitride (“AlN”), molybdenum disilicide (“MoSi₂”), and silicon carbide (“SiC”). However, while the Mini-Igniter™ is a highly effective product, certain applications require voltages in excess of 120 V.

Further, many current ceramic igniters also have suffered from breakage during use, particularly in environments where impacts may be sustained such as igniters used for gas cooktops and the like. Further, it is difficult to use conventional fabrication methods to produce heating elements having certain desired properties. In particular, while conventional fabrication methods may aim to produce a heating element or a batch of heating elements having a certain set of properties, it is not always possible to produce a heating element having the exact set of desired properties, or to produce a batch of heating elements all having the exact set of desired properties (and a uniform set of properties for the entire batch, i.e. one heating element may have some variation in its properties compared to another heating element from the same batch).

It, thus, would be desirable to provide ceramic heating elements with improved properties. It also would be desirable to provide new ceramic igniters that could be employed in a variety of applications. It would be particularly desirable to have new igniter compositions that could reliably operate at high voltages. It also would be desirable to have new igniters with good mechanical integrity. It would further be desirable to provide methods of fabricating heating elements and batches of heating elements wherein the desired properties of the end product can be reliably produced and reproduced.

### SUMMARY OF THE INVENTION

We now provide new ceramic igniters and methods of fabrication thereof.

In one aspect, the igniters comprise at least one first zone of material having a first resistivity and an electrical pathway thereon, and a surface pattern disposed on or within at least one surface of the first zone, the surface pattern providing one or more interruptions in the electrical pathway, whereby an increased electrical pathway is defined on the at least one surface and around the one or more interruptions.

Embodiments according to this aspect can include the following features. The surface pattern can comprise one or more grooves in the surface of the first zone and whereby the increased electrical pathway extends on the at lease one surface and around the one or more grooves. The one or more grooves are further filled with a material having a resistivity different than the first resistivity. The surface pattern comprises one or more protrusions in the surface of the first zone and whereby the increased electrical pathway extends on the at lease one surface and around the one or more protrusions. The one or more protrusions are formed of a material having a resistivity different than the first resistivity. The surface pattern increases the resistance in the area in which the surface pattern is disposed. The at least one first zone of material comprises a conductive material. The surface pattern is provided in the conductive material to provide one or more resistive hot zones. The surface pattern is provided in the conductive material to provide one or more intermediate zones of resistivity. The at least one first zone of material is provided in a U-shape. The at least one first zone of material comprises a pair of conductive legs, and the igniter further comprises at least one second zone of resistive material disposed between and in electrical connection with the pair of conductive legs. An insulator is further provided within the U-shape or between the conductive legs and in contact with the hot zone. The surface pattern comprises one or more grooves extending through the first zone of material and/or the second zone or material to expose the insulator. The igniter is a coaxial igniter and the coaxial igniter further comprises at least one second zone of material and third zone of material, wherein the second zone of material comprises a core conductive region, the first zone of material comprises an outer conductive region, and the third zone of material comprises an insulator region disposed between the core region and outer region. The surface pattern is provided at a distal end of the coaxial igniter to thereby form a resistive hot zone region at the distal end. The one or more grooves extend through the entire thickness of the outer region to expose the insulator region. The igniter further comprises a fourth zone of material at the distal end of the coaxial igniter mating with the conductive core region, the fourth zone of material being a resistive material. The surface pattern comprises one or more grooves or protrusions positioned in a spiral pattern about at least a portion of the outer conductive region. The surface pattern comprises one or more grooves or protrusions in the form of non-intersecting parallel lines disposed perpendicular to the longitudinal axis of the igniter. The igniter has a rounded cross-sectional shape for at least a portion of the igniter length.

In another aspect, a method for modifying the resistance at least one region of a ceramic igniter is provided wherein the method comprises forming the ceramic igniter and densifying the ceramic igniter, wherein the densified ceramic igniter comprises at least one first zone of material having a first resistivity, and wherein the igniter has an electrical pathway in the first zone; disposing a surface pattern on or within at least one surface of the first zone of the densified ceramic igniter, wherein the surface pattern provides one or more interruptions in the electrical pathway to thereby form an increased electrical pathway on the at least one surface and around the one or more interruptions.

In another aspect, a method for modifying the length of the electrical pathway at least one region of a ceramic igniter is provided wherein the method comprises forming the ceramic igniter and densifying the ceramic igniter, wherein the densified ceramic igniter comprises at least one first zone of material having a first resistivity, and wherein the igniter has an electrical pathway in the first zone; disposing a surface pattern on or within at least one surface of the first zone of the densified ceramic igniter, wherein the surface pattern provides one or more interruptions in the electrical pathway to thereby form an increased electrical pathway on the at least one surface and around the one or more interruptions.

Embodiments according to either of these methods can include the following features. The increased electrical pathway formed by the one or more interruptions increases the resistance through the ceramic igniter. The step of disposing a surface pattern comprises forming one or more grooves in the surface of the first zone, whereby the increased electrical pathway extends on the at lease one surface and around the one or more grooves. The method further comprises inserting into one or more grooves a material having a resistivity different than the first resistivity. The step of disposing a surface pattern comprises disposing one or more protrusions in the surface of the first zone, whereby the increased electrical pathway extends on the at lease one surface and around the one or more protrusions. The step disposing one or more protrusions in the surface of the first zone comprises disposing a material on the surface of the first zone, wherein the disposed material has a resistivity different than the first resistivity.

In another aspect, a method for modifying the length of the electrical pathway at least one region of a ceramic igniter is provided wherein the method comprises forming the ceramic igniter and densifying the ceramic igniter, wherein the densified ceramic igniter comprises at least one first zone of material having a first resistivity and a burn-out material disposed within the first zone, wherein the igniter has an electrical pathway in the first zone; firing the densified ceramic igniter such that the burn-out material burns to leave one or more interruptions in the electrical pathway to thereby form an increased electrical pathway on the at least one surface and around the one or more interruptions.

Embodiments according to this method can include the following features. The increased electrical pathway formed by the one or more interruptions increases the resistance through the ceramic igniter.

In another aspect, the invention generally relates to a method of igniting gaseous fuel, comprising applying an electric current across an igniter in accordance with any of the embodiments set forth herein. Embodiments according to this aspect of the invention can include the following features. The current can have a nominal voltage of 6, 8, 9, 10, 12, 24, 120, 220, 230 or 240 volts.

In another aspect, the invention generally relates to a heating apparatus comprising an igniter in accordance with any of the embodiments set forth herein.

Other aspects of the invention are disclosed infra.

### BRIEF DESCRIPTION OF THE DRAWINGS

FIG. 1 shows a U-shaped heating element which can be provided with grooves in accordance with the present invention.

FIG. 2 shows a “slotless” design for a heating element which can be provided with grooves in accordance with the present invention.

FIG. 3 shows a heating element having a rectangular core surrounded by two conductive legs having an interposed void space which can be provided with grooves in accordance with the present invention.

FIG. 4 shows an embodiment of a coaxial heating element which can be provided with grooves in accordance with the present invention.

FIG. 5 shows a cross-sectional view of a coaxial heating element which can be provided with grooves in accordance with the present invention.

FIG. 6 shows a cut-away view of a coaxial heating element which can be provided with grooves in accordance with the present invention.

FIGS. 7a-c show embodiments of coaxial heating elements which can be provided with grooves in accordance with the present invention.

FIGS. 8a-b show an embodiment of a coaxial heating element before and after providing grooves in accordance with the present invention.

FIGS. 9a-9e show embodiments of various groove designs in accordance with the present invention.

FIG. 10 shows an embodiment of a coaxial heating element provided with a spiral groove at the tip of the heating element in accordance with an embodiment of the present invention.

FIGS. 11a-d shows heating elements in use before (FIGS. 11a and c),and after

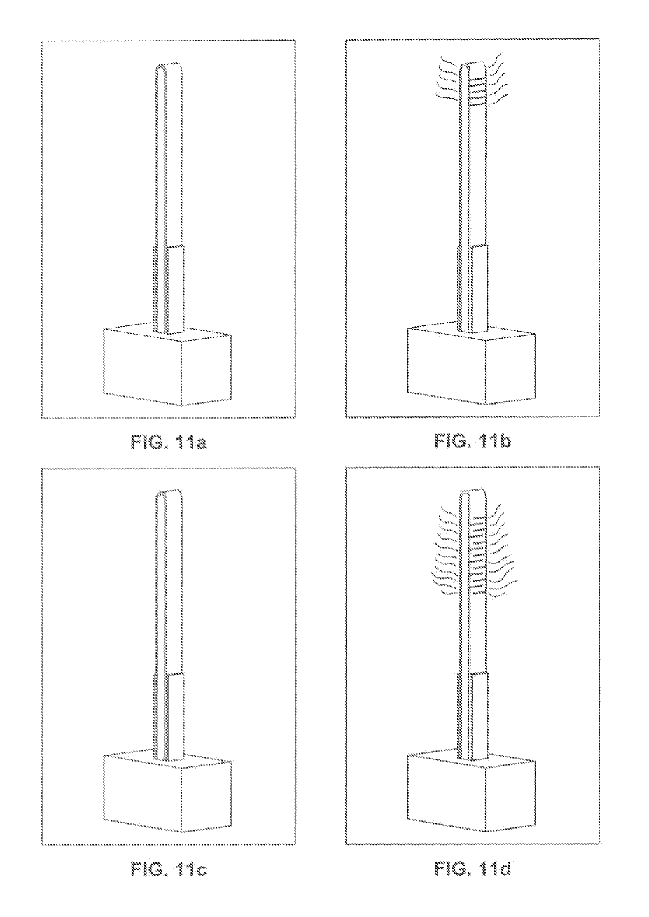

(FIGS. 11b and d) grooves are provided in accordance with embodiments of the present invention.

### DETAILED DESCRIPTION

New ceramic heating elements and methods for manufacture are provided. The heating elements of the invention can be provided in any conventional shape and form. The heating elements of the invention include at least a portion wherein a surface pattern is disposed so as to provide one or more interruptions in the electrical pathway through the heating element such that the electrical pathway is thereby lengthened by the one or more interruptions (e.g. as compared to the electrical pathway without the one or more interruptions). In particular, a heating element can comprise a first zone of material having a first resistivity. The first zone of material has an electrical pathway thereon. A surface pattern is disposed on or within at least one surface of the first zone wherein the surface pattern provides one or more interruptions in the electrical pathway. As a result, an increased electrical pathway is defined on the at least one surface and around the one or more interruptions.

In some embodiments, the one or more interruptions can be provided by one or more grooves. As used herein, a “groove” is understood to mean a cut, indentation, channel, furrow, depression, or the like formed in a surface. Such “grooves” can extend any depth from the surface through the material in which the groove is provided. For example, a groove can extend through the entire thickness of a material from its surface, or through any fraction or percent of the thickness of a material from its surface. As used herein, a “plurality of grooves” is understood to mean two or more “grooves”, and can also refer to a single continuous groove that encircles or spirals or otherwise winds about the surface of a structure (e.g. similar to a thread around a screw). Such grooves can include one or more grooves that are all identical or one or more grooves that can differ from each other in, for example, thickness, depth, spacing from other adjacent grooves, etc. In the case of a single continuous groove, included are those that are relatively uniform throughout its length (e.g. in depth from the surface, thickness, spacing from adjacent spirals or “pitch” as in a thread of a screw), and those that can vary along its length (e.g. in depth from the surface at one or more points along its length, and/or that varies in thickness at one or more points along its length, and/or that varies in spacing from adjacent spirals or “pitch” as in a thread of a screw). Such grooves can be formed by any suitable methods such as, for example, machining, laser, grinding, mask and acid etching, etc. Further grooves can also be formed by the use of a burn-out material. In particular, an igniter can be fabricated with a burn-out material positioned within the igniter such that, upon heating to sufficient temperature (e.g. during firing), the burn-out material burns to leave one or more grooves. Such burn-out materials and methods are well known and, as such, the particular burn-out materials used and methods for heating, etc. can be in accordance with known materials and methods and can be suitably selected in view of, e.g. the desired firing time, surface pattern, etc.

In some embodiments, the one or more interruptions can be provided by one or more protrusions. As used herein, a “protrusion” is understood to mean a portion that is raised above the level of the surrounding surface. Such “protrusions” can be raised from the surface at any height. As used herein, a “plurality of protrusions” is understood to mean two or more “protrusions”, and can also refer to a single continuous protrusion that encircles or spirals or otherwise winds about the surface of a structure (e.g. similar to a thread around a screw). Such protrusions can include one or more protrusion that are all identical or one or more protrusions that can differ from each other in, for example, thickness, height, spacing from other adjacent protrusions, etc. In the case of a single continuous protrusion, included are those that are relatively uniform throughout its length (e.g. in height above the surface, thickness, spacing from adjacent spirals or “pitch” as in a thread of a screw), and those that can vary along its length (e.g. in height above the surface at one or more points along its length, and/or that varies in thickness at one or more points along its length, and/or that varies in spacing from adjacent spirals or “pitch” as in a thread of a screw).

As described, the surface pattern can provide one or more interruptions in the electrical pathway through the heating element such that the electrical pathway is thereby lengthened by the one or more interruptions. This lengthening of electrical pathway can result in a modified electrical resistance through the heating element (e.g. as compared with the resistance of the heating element without the surface pattern), particularly an increased electrical resistance. In some embodiments, the heating element is provided with one zone of electrical resistance (a single electrical resistance) and one or more portions of the element is provided with one or more surface patterns. The one or more surface patterns provide one or more interruptions in the electrical pathway through the heating element such that the resistivity through those portions is modified, particularly wherein the resistivity is increased. Any number of surface patterns can be provided at any number of locations in the heating element so as to provide areas of different electrical resistance which are created by the surface patterns.

In such embodiments wherein the heating element is provided initially (prior to disposition of surface pattern(s)) with one zone of electrical resistance, in the event that the surface pattern includes one or more grooves, the groove(s) will typically not extend through the entire thickness of the material forming the element, but, rather, will extend a certain depth from the surface of the material. By providing a groove in the material, an electrical pathway through the material is formed such that the pathway follows the non-grooved surface. However, because an electrical current will tend to traverse the shortest distance (shortest pathway) and/or the lowest impedance (along the non-grooved-surface), some electrical current will also traverse across the grooves (which forms the shortest pathway). In this case, the depth of the grooves can adjusted so as to further inhibit the current from traversing the pathway (by making the depth of the grooves deeper). Further, in some embodiments, a material having a resistivity different than the one zone of electrical resistance can be inserted into the one or more grooves so as to further inhibit the electrical current from traversing across the grooves. Any amount of this different material can be provided in the groove as desired.

In other embodiments, heating elements include two or more zones of differing electrical resistance prior to (or regardless of) a surface pattern provided in accordance with the present invention. For example, in some embodiments, prior to/regardless of any surface pattern provided in accordance with the present invention, the elements include at least two zones of differing electrical resistance comprising a first conductive zone of relatively low resistance and a hot or ignition zone of relatively high resistance. An insulator zone can further be provided if desired. In some embodiments, prior to/regardless of any surface pattern provided in accordance with the present invention, the elements (with or without an insulator zone) further include a third zone comprising a power booster or enhancement zone of intermediate resistance. Preferably the zones of differing electrical resistance are in sequence, e.g. a first conductive zone of relatively low resistance, followed by the zone of intermediate resistance (when provided), followed by the zone of high resistance. In some embodiments, prior to/regardless of any surface pattern provided in accordance with the present invention, the elements include two or more zones of differing electrical resistance comprising a first conductive zone and an insulator zone.

The geometry of the heating element 10 can vary and can be in accordance with those generally known. For example, in some embodiments, substantially U-shaped elements such as those depicted in FIG. 1 are provided. Such U-shaped elements can generally include a) a pair of electrically conductive zones or “legs” 12 of relatively low resistance, each zone or leg having a first end, and b) a hot zone 14 of relatively high resistance disposed between and in electrical connection with each of the first ends of the electrically conductive zones or legs, for example, as shown in FIG. 1. Such configurations are also referred to as a “slotted” hairpin design, wherein a void space is interposed between conductive and hot zones.

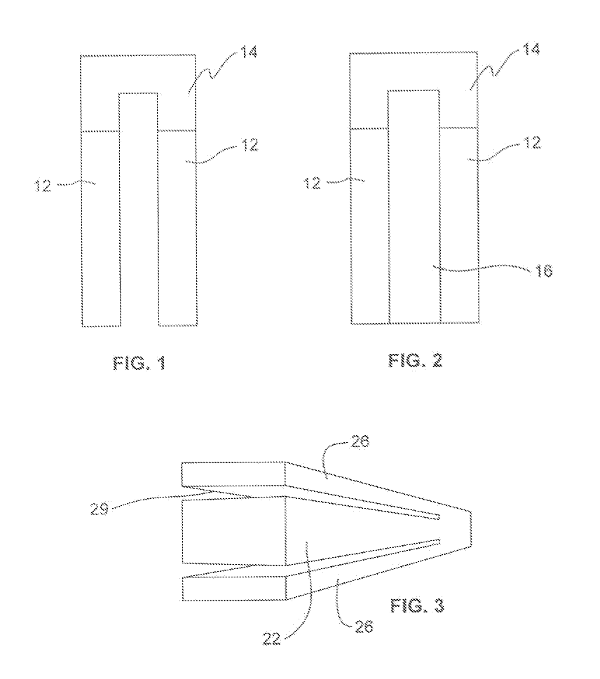

In some embodiments, an electrically non-conductive zone (heat sink or insulator)16 is further in contact with the hot zone region, preferably interposed or inserted between the conductive zones and in contact with the hot zone (e.g. in the void space), for example, as shown in FIG. 2. Such configurations are also referred to as a “slotless” design and are disclosed in, for example, U.S. Pat. Nos. 6,002,107, 6,028,292 and 6,278,087.

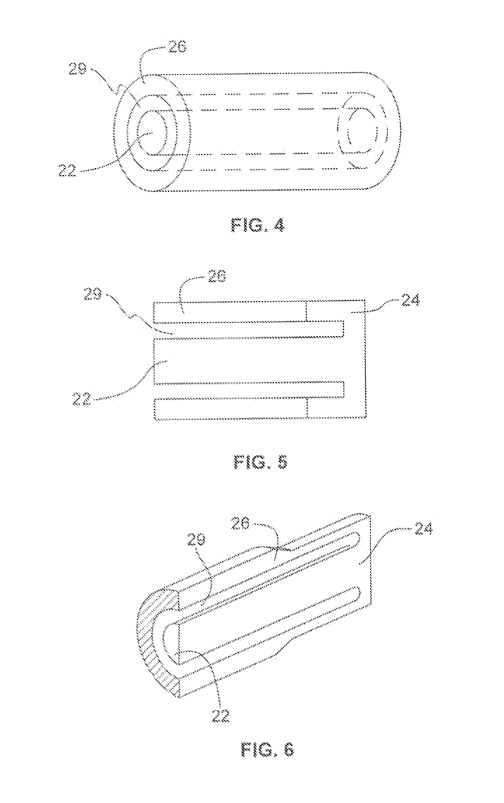

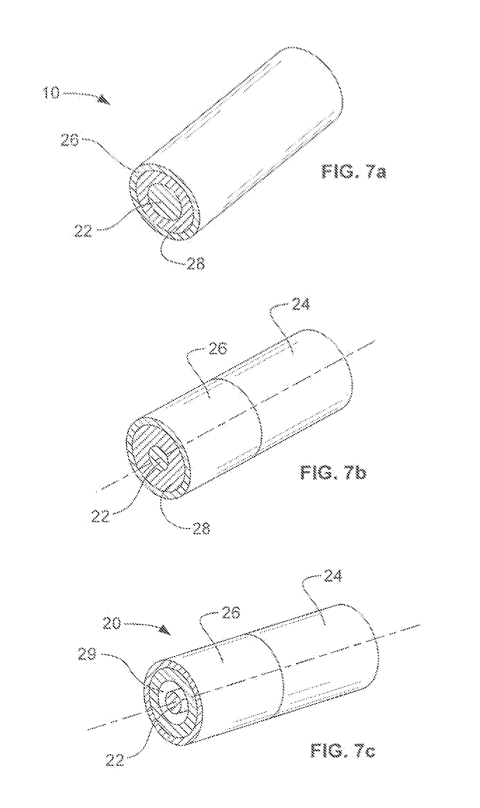

Coaxial configurations can also be provided (e.g. as depicted in FIGS. 4-7c, and as disclosed in U.S. patent application Ser. No. 12/317,924). Such coaxial configurations generally comprise a first conductive zone 22 and a hot resistive zone 24 at the distal end of the element that, in turn, mates with a second conductive zone that forms an outer region 26. The first conductive zone (“conductive core”) 22 and second outer conductive zone 26 can, in some embodiments, be segregated, at least in part, by an insulator region 28. In some embodiments, the first conductive zone (“conductive core”) and second outer conductive zone can be segregated, at least in part, by a void space 29. In some embodiments, at least a portion of the conductive core region does not contact a ceramic insulator. In some embodiments, the elements are further substantially rod-shaped (e.g. rounded cross-sectional shape such as substantially circular cross-sectional area)(e.g. see FIGS. 7a-7c).

As referred to herein, the term “insulator” or “electrically insulating material” indicates a material having a room temperature resistivity of at least about 10¹⁰ ohms-cm. The electrically insulating material component of heating elements of the invention may be comprised solely or primarily of one or more metal nitrides and/or metal oxides, or alternatively, the insulating component may contain materials in addition to the metal oxide(s) or metal nitride(s). For instance, the insulating material component may additionally contain a nitride such as aluminum nitride (AlN), silicon nitride, SiALON, or boron nitride; a rare earth oxide (e.g. yttria); or a rare earth oxynitride.

As referred to herein, a semiconductor ceramic (or “semiconductor”) is a ceramic having a room temperature resistivity of between about 10 and 10⁸ ohm-cm. If the semiconductive component is present as more than about 45 v/o of a hot zone composition (when the conductive ceramic is in the range of about 6-10 v/o), the resultant composition becomes too conductive for high voltage applications (due to lack of insulator). Conversely, if the semiconductor material is present as less than about 5 v/o (when the conductive ceramic is in the range of about 6-10 v/o), the resultant composition becomes too resistive (due to too much insulator). Again, at higher levels of conductor, more resistive mixes of the insulator and semiconductor fractions are needed to achieve the desired voltage. Typically, the semiconductor is a carbide from the group consisting of silicon carbide (doped and undoped), and boron carbide.

As referred to herein, a “conductive material” is one which has a room temperature resistivity of less than about 10⁻² ohm-cm. Conductive materials are also referred to herein as low resistivity materials. In general, if the conductive component is present in an amount of more than 35 v/o of the hot zone composition, the resultant ceramic can become too conductive. Typically, the conductor is selected from the group consisting of molybdenum disilicide, tungsten disilicide, and nitrides such as titanium nitride, and carbides such as titanium carbide. Molybdenum disilicide is generally preferred.

For any of the ceramic compositions (e.g. insulator, conductive material, semiconductor material, resistive material), the ceramic compositions may comprise one or more different ceramic materials (e.g. SiC, metal oxides such as Al₂O₃, nitrides such as AlN, Mo₂Si₂ and other Mo-containing materials, SiAlON, Ba-containing material, and the like). Alternatively, distinct ceramic compositions (i.e. distinct compositions that serve as insulator, conductor and resistive (ignition) zones in a single heating element) may comprise the same blend of ceramic materials (e.g. a binary, ternary or higher order blend of distinct ceramic materials), but where the relative amounts of those blend members differ, e.g. where one or more blend members differ by at least 5, 10, 20, 25 or 30 volume percent between the respective distinct ceramic compositions.

A variety of compositions may be employed to form a heating element of the invention. Generally preferred hot zone compositions comprise at least three components of 1) conductive material; 2) semiconductive material; and 3) insulating material. Conductive (cold) and insulative (heat sink) regions may be comprised of the same components, but with the components present in differing proportions, as mentioned above. Typical conductive materials include e.g. molybdenum disilicide, tungsten disilicide, nitrides such as titanium nitride, and carbides such as titanium carbide. Typical semiconductors include carbides such as silicon carbide (doped and undoped) and boron carbide. Typical insulating materials include metal oxides such as alumina or a nitride such as AlN and/or Si₃N₄.

In general, preferred hot (resistive) zone compositions include (a) between about 50 and about 80 v/o of an electrically insulating material having a resistivity of at least about 10¹⁰ ohm-cm; (b) between about 5 and about 45 v/o of a semiconductive material having a resistivity of between about 10 and about 10⁸ ohm-cm; and (c) between about 5 and about 35 v/o of a metallic conductor having a resistivity of less than about 10⁻² ohm-cm. Preferably, the hot zone comprises 50-70 v/o electrically insulating ceramic, 10-45 v/o of the semiconductive ceramic, and 6-16 v/o of the conductive material. A specifically preferred hot zone composition for use in heating elements of the invention contains 10 v/o MoSi₂, 20 v/o SiC and balance AlN or Al₂O₃.

It has been found that providing one or more surface patterns in at least a portion of a heating element, in particular wherein the one or more surface patterns provide one or more interruptions in the electrical pathway, advantageously increases the effective resistance of that portion of the heating element.

For example, in some embodiments, by providing one or more grooves and/or protrusions in a low resistivity material of a heating element wherein the one or more grooves and/or protrusions interrupt the electrical pathway through the material, the effective resistance of that low resistivity material can be increased. In particular, in that portion of the low resistivity material wherein one or more interruptions are provided, the resistance through that portion of material is increased. As a result, a zone of localized heating (P_{local}=I²R_{local}) is created in the portion containing the interruption(s), and higher voltage heating elements can be provided. Further, by providing one or more interruptions (e.g. grooves and/or protrusions) in a heating element, it is possible to finely tailor the final electrical properties (e.g., voltage, power) and their distribution within the element. This can be done by, for example, the placement, size, and number of interruptions (e.g. grooves and/or protrusions) in the heating element.

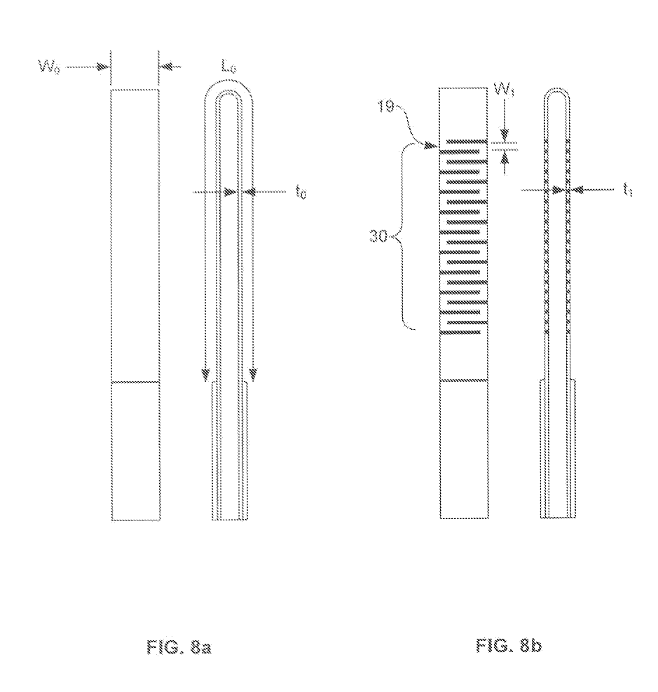

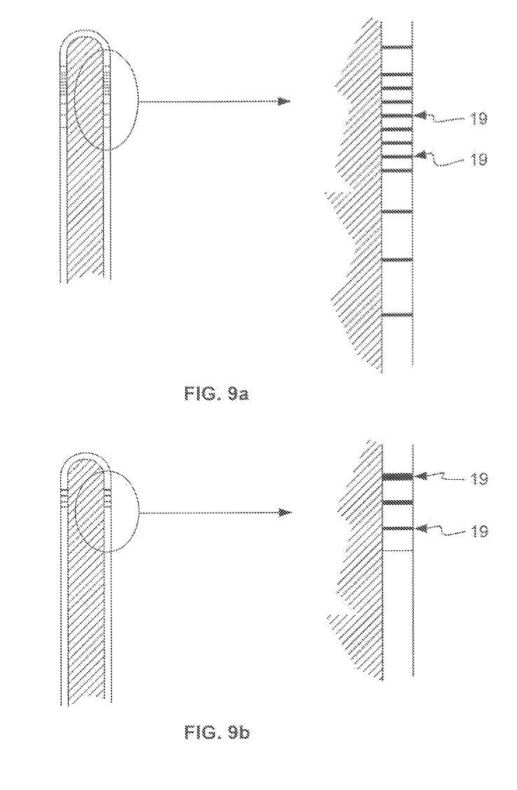

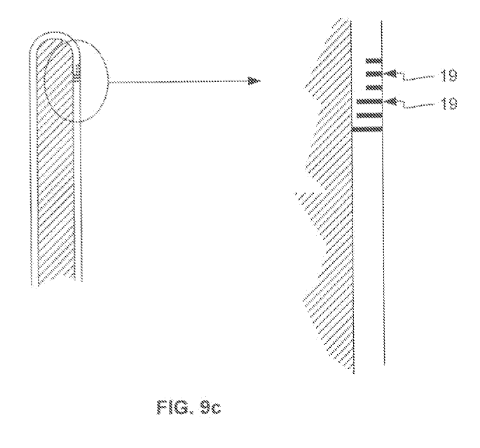

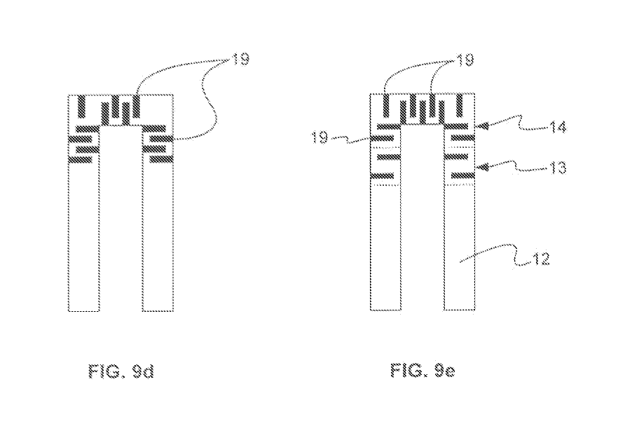

In embodiments wherein a U-shaped heating element is provided comprising a pair of electrically conductive legs of relatively low resistance, a hot zone of relatively high resistance disposed between and in electrical connection with each the electrically conductive legs (optionally, in some embodiments, a third zone comprising a power booster or enhancement zone of intermediate resistance), and a void space is interposed between conductive and hot zones (e.g. FIG. 1), in the case where one or more interruptions include one or more grooves, the groove(s) would generally be provided in the conductive legs so as to extend a depth into legs from the surface “d” less than the total thickness of the legs. In some embodiments, the depth of the grooves is uniform throughout the conductive zone. Further, the thickness of the grooves, and/or spacing between grooves can also be uniform throughout. In other embodiments, the design of the grooves can vary (e.g. in depth, thickness, and/or spacing between grooves), and some examples are shown in FIGS. 9a-9e wherein grooves are shown as 19. By providing the grooves 19 in the conductive zone, the electrical pathway is created that extends through the non-grooved portion, (e.g. FIG. 8b, 10), thereby increasing resistance and providing a zone of localized heating. However, as noted above, some electrical current may tend to pass across the grooves if it provides a shorter electrical pathway. Thus, the depth of the grooves can be modified as desired to reduce or prevent this and/or, if desired, a material of differing resistivity can be inserted within the grooves so as to further reduce or prevent this.

In some embodiments, a U-shaped heating element is provided that has one zone of electrical resistance, and one or more portions of the element include one or more interruptions (e.g. one or more grooves and/or protrusions). For example, a hot zone 14 can be provided (e.g. as shown in FIG. 9d) at the “bridge” or connecting portion of the “U” (or at any other desired location) by providing one or more grooves 19 (and/or protrusions, not shown) at that portion of the device, which increases resistance through that portion of the device. As such, simple heating elements of a single material can easily be formed and provided with zones of varying electrical resistance by the formation of a surface pattern (e.g. including interruption(s) in the form of one or more grooves and/or protrusions). Further, one or more zones of intermediate resistance (power booster zone) 13 can further be provided by including one or more grooves 19 (and/or protrusions, not shown) that will increase the resistance in that portion of the element such that it is (a) greater than the portions that do not include grooves and/or protrusions (and, thus, form a conductive/relatively low resistance zone) but (b) less than the portion having grooves and/or protrusions provided to create a hot zone. This can be done, for example, by providing the grooves 19 (and/or protrusions, not shown) to provide the hot zone 14 and providing the grooves 19 (and/or protrusions, not shown) to provide the power booster zone 13 (e.g. as shown in FIG. 9e wherein the grooves 19 providing the hot zone are packed closer together and wherein the grooves 19 providing the power booster zone 13 are spaced further apart).

In embodiments wherein a generally U-shaped heating element is provided with an electrically non-conductive zone (heat sink or insulator) interposed or inserted within the void of the U-shape (e.g. FIG. 2), the U-shaped heating element can be provided with one zone of electrical resistance as described above, and one or more portions of the element can include one or more surface patterns (one or more interruptions in the form of, e.g. one or more grooves and/or protrusions). For example, a hot zone can be provided at the “bridge” or connecting portion of the “U” (or at any other desired location) by providing one or more interruptions (e.g. grooves and/or protrusions) at that portion of the device, which increases resistance through that portion of the device, similar to that shown in FIGS. 9a-9b. As described above, one or more intermediate “power booster” zones can also be provided by including one or more interruptions (e.g. grooves and/or protrusions) at suitable location(s). In other embodiments, a generally U-shaped heating element includes two or more zones of electrical resistance (e.g. a pair of electrically conductive legs of relatively low resistance, a hot zone of relatively high resistance disposed between and in electrical connection with each the electrically conductive legs, optionally one or more power booster zones of intermediate resistance, and an electrically non-conductive zone interposed or inserted between the conductive zones and in contact with the hot zone), one or more surface patterns (interruptions in the form of, e.g. grooves and/or protrusions) are further provided in the element. In some embodiments, one or more grooves and/or protrusions are provided in the conductive zone (relatively low resistivity material). In these embodiments, one or more grooves, if provided, can be formed so as to extend through the entire thickness of the conductive zone to expose the interposed non-conductive zone and, thereby, create an electrical pathway on the surface of the conductive zone which is defined by the exposed insulative zone.

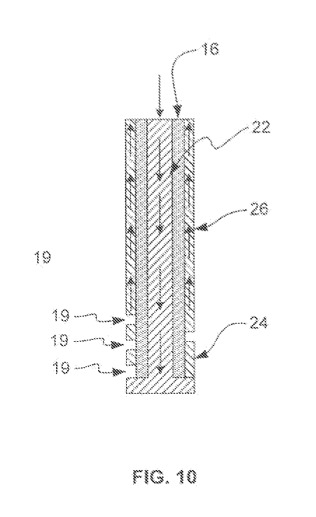

In embodiments wherein a heating element having a coaxial configuration is used (e.g. FIGS. 4-7c, in the case that the surface pattern includes one or more grooves, the groove(s) can be provided in the outer zone or layer (e.g. conductive material) so as to extend through the entire thickness of the outer layer to expose the underlying material which can have a different resistivity (e.g. see FIG. 10, wherein a non-conductive insulator material 16 is positioned between the inner conductive core 22 and the outer layer 26, and the grooves 19 expose the insulator material so as to form a heating tip/hot zone 24 with an outer conductive spiral). In other embodiments, the groove(s) can extend a depth “d” from the surface of the outer zone or layer (e.g. conductive material) that is less than the total thickness of the outer layer. If desired, one or more materials having a different resistivity than the outer layer can also be inserted within the groove(s) as discussed herein. In some embodiments, to minimize electrical current from passing across the grooves, it can be preferred in some embodiments to form grooves that extend to a depth or thickness that exposes the underlying material (e.g. insulator material). In some embodiments, combinations of groove depths (and/or protrusion height) can be provided, and in other embodiments the depth of the grooves (and/or protrusion height) is uniform throughout the conductive zone. The design of the surface patterns (interruptions in the form of, e.g. grooves and/or protrusions) can vary. For example, in some embodiments, one or more interruptions (e.g. grooves and/or protrusions) are provided in at least a portion of the outer conductive layer so as to provide increased resistance in that portion of the conductive zone. On other embodiments, one or more interruptions (e.g. grooves and/or protrusions) can be provided at the tip of the device to create a hot tip section (e.g. as shown in FIG. 10).

It was unexpectedly found that providing one or more interruptions in the electrical pathway (electrical pathway prior to one or more interruptions) of a heating element in accordance with the present invention can increase the resistance of the heating element (as compared with the heating element without one or more interruptions) and, thus, provides a higher voltage system. It is known that the resistance of any body is generally governed by the equation:

R=ρ×L/A

wherein

### R=Resistance;

p=Resistivity;
L=the length of the conductor; and
A=the cross-sectional area of the conductor.
A heating element, such as that shown in FIG. 8a, thus, has a resistance, R₀, as follows:
R₀=ρ×L₀/(w₀×t₀)
with A=w₀×t₀

When the same heating element is provided with a plurality of interruptions (e.g. grooves and/or protrusions), for example, as shown by the grooves 19 formed in the element of FIG. 8b, the resistance, R₁, becomes:

R₁=ρ×2L₁/(w₁×t₁)

In particular, the length of the conductor (low resistance material) increases to 2L₁ (wherein L₁ is the length of each “leg” of the conductor), while the width of the electrical pathway through the conductor decreases from w₀ to w₁, as depicted in FIG. 8b. As is clear from FIGS. 8a and 8b, L₁>>L₀, w₁<w₀, t₁ =tₒ. As a result, the resistance R₁ of the heating elements in accordance with the present invention (for example, as depicted in FIG. 8b in accordance with one embodiment) is much greater than the resistance Rₒ of the same heating element without grooves in the conductor (i.e. FIG. 8a). Thus, the heating element as depicted in FIG. 8b is provided with a zone of localized heating, shown as 30, which is due to the increase in resistance in this zone. This increase in resistance is a result of the increase of the effective path length and reduction in cross-sectional area provided by the one or more interruptions (“grooves”) provided in the device. As a result, the heating elements are provided with higher operational voltages, wherein voltage is calculated as:

V=IR

with
V=voltage;
I=current; and
R=resistance.

The present heating elements are capable of providing an increase in resistance in an area of a heating element in which a surface pattern (interruptions formed by, e.g. one or more grooves and/or protrusions) is provided that is at least 1 times larger than resistance through the same heating element area without one or more interruptions provided. In some embodiments, the resistance is increased by at least 1.5 times, by 2 times, by 2.5 times, by 3 times, by 3.5 times, by 4 times, by 4.5 times, by 5 times, by 5.5 times, by 6 times, by 6.5 times, by 7 times, by 7.5 times, by 8 times, by 8.5 times, by 9 times, by 9.5 times, and even by 10 times and greater. However, using the above equations, one can tailor a heating element by providing a particular configuration of interruption(s) so as to provide the element with any desired modification to resistance.

The present heating elements are further capable of providing an increase in voltage in a heating element in which one or more a surface pattern (interruptions formed by, e.g. one or more grooves and/or protrusions) is provided that is at least 10% greater than the same heating element without one or more interruptions, in some embodiments, at least 15%, at least 20%, at least 30%, at least 40%, at least 50%, at least 60%, at least 70%, at least 80%, at least 90%, at least 100%, at least 110%, at least 120%, at least 130%, at least 140%, at least 150%, at least 160%, at least 170%, at least 180%, at least 190%, at least 200%, and even greater. However, using the above equations, one can tailor a heating element by providing a particular configuration of interruption(s) so as to provide the element with any desired modification of voltage.

Ceramic igniters of the invention can be employed with a variety of voltages, including nominal voltages of 6, 8, 12, 24 and 120 volts, and for higher voltages up to 264 volts, e.g. ranging from 187 to 264 volts. Igniters of the invention can heat rapidly from room temperature to operational temperatures, e.g. to about 1300° C. For example, igniters can heat to operational temperatures in about 4 seconds or less, even 3 seconds or less, or even 2.75 or 2.5 second or less.

The processing of the ceramic component (i.e., green body processing and sintering conditions) and the preparation of the element from the densified ceramic can be done by conventional methods. Typically, such methods are carried out in substantial accordance with the incorporated U.S. Pat. No. 5,786,565 to Willkens et al. and U.S. Pat. No. 5,191,508 to Axelson et al. Preferably, a plurality of elements of the invention are produced simultaneously, e.g. at least 5, more typically at least 10 or 20, still more typically at least about 50, 60, 70, 80, 90 or 100, from a single sheet material (e.g. billet sheet), such methods can be carried out in substantial accordance with the incorporated U.S. Pat. No. 6,278,087 to Willkens et al. More typically, up to about 100 or 200 elements are suitably produced substantially simultaneously.

After the elements are produced, one or more portions of the element (e.g. relatively low resistivity/conductive material) can be further processed to provide a surface pattern using any suitable method. For example, one or more interruptions can be provided in the form of, e.g. one or more grooves and/or protrusions, using any suitable method such as, but not limited to machining, laser, grinding, mask and acid etching, use of burn-out materials etc.

Methods of the invention are particularly advantageous because it is possible to produce a heating element and, post-densification, tailor specific properties of the heating element as desired. In particular, with prior methods, heating elements are designed and densified to an end product having a set of end properties—this was the end product. Such methods require that the fabrication method be designed from the beginning so as to produce the end product with the desired properties. While this is possible, such methods often provide end products that, while close, may not possess the precise set of desired end properties. Further, methods that require such pre-determination of end properties prior to fabrication can be time consuming and costly. The present methods allow for the fabrication a large number of densified heating elements formed from any desired materials (wherein all of the elements are the same and, thus, a single fabrication for all the elements through densification) and, after densification, each individual element can be provided with a precise set of end properties by providing a surface pattern in accordance with the present invention. Thus, for example, if three batches of heating elements are required, and each batch requires a different set of properties, one can use the present methods to produce a single large batch of densified elements and, post-densification, split the single large batch into three batches and provide each of the three batches with the required set of properties needed for each of the three batches.

Methods of igniting gaseous fuel are also provided, which in general comprise applying an electric current across an igniter of the invention.

The following non-limiting examples are illustrative of the invention. All documents mentioned herein are incorporated herein by reference in their entirety.

### EXAMPLE 1

An igniter of the invention was prepared and tested as follows.

As demonstrated in FIGS. 11a-d, elements provided with grooves in various configurations provides greater resistance and voltage at the same temperature levels. For example, laser cutting a plurality of grooves in a “ladder” pattern, increased the room temperature resistance from 2.8 Ω (FIG. 11a, which depicts the element before providing grooves) to 24.7 Ω (FIG. 11b, which depicts the element of FIG. 11a after ladder cutting a plurality of grooves) and voltage increased from 42 V at 1300° C. (FIGS. 11a) to 123 V at 1300° C. (FIG. 11b) . Laser cutting a plurality of grooves in a “rectangle” pattern, increased room temperature resistance from 2.8 Ω (FIG. 11c, which depicts the element before providing grooves) to 4.0 Ω (FIG. 11d, which depicts the element of FIG. 11c after cutting a plurality of rectangle grooves), and voltage increased from 42 Vat 1300° C. (FIGS. 11c) to 55 Vat 1300° C. (FIG. 11d).

The invention has been described in detail with reference to particular embodiments thereof. However, it will be appreciated that those skilled in the art, upon consideration of this disclosure, may make modification and improvements within the spirit and scope of the invention.

What is claimed is:

1. A ceramic igniter comprising:
at least one first zone of material having a first resistivity and an electrical pathway thereon; and
a surface pattern disposed on or within at least one surface of the first zone, the surface pattern providing one or more interruptions in the electrical pathway, whereby an increased electrical pathway is defined on the at least one surface and around the one or more interruptions.

2. The ceramic igniter of claim 1 wherein the surface pattern comprises one or more grooves in the surface of the first zone and whereby the increased electrical pathway extends on the at lease one surface and around the one or more grooves.

3. The ceramic igniter of claim 2 wherein the one or more grooves are further filled with a material having a resistivity different than the first resistivity.

4. The ceramic igniter of claim 1 wherein the surface pattern comprises one or more protrusions in the surface of the first zone and whereby the increased electrical pathway extends on the at lease one surface and around the one or more protrusions.

5. The ceramic igniter of claim 4 wherein the one or more protrusions are formed of a material having a resistivity different than the first resistivity.

6. The ceramic igniter of claim 1 wherein the surface pattern increases the resistance in the area in which the surface pattern is disposed.

7. The ceramic igniter of claim 1, wherein the at least one first zone of material comprises a conductive material.

8. The ceramic igniter of claim 7 wherein the surface pattern is provided in the conductive material to provide one or more resistive hot zones.

9. The ceramic igniter of claim 7 wherein the surface pattern is provided in the conductive material to provide one or more intermediate zones of resistivity.

10. A method for modifying the resistance at least one region of a ceramic igniter comprising:
forming the ceramic igniter and densifying the ceramic igniter, wherein the densified ceramic igniter comprises at least one first zone of material having a first resistivity, and wherein the igniter has an electrical pathway in the first zone;
disposing a surface pattern on or within at least one surface of the first zone of the densified ceramic igniter, wherein the surface pattern provides one or more interruptions in the electrical pathway to thereby form an increased electrical pathway on the at least one surface and around the one or more interruptions.

11. A method for modifying the length of the electrical pathway at least one region of a ceramic igniter comprising:
forming the ceramic igniter and densifying the ceramic igniter, wherein the densified ceramic igniter comprises at least one first zone of material having a first resistivity, and wherein the igniter has an electrical pathway in the first zone;
disposing a surface pattern on or within at least one surface of the first zone of the densified ceramic igniter, wherein the surface pattern provides one or more interruptions in the electrical pathway to thereby form an increased electrical pathway on the at least one surface and around the one or more interruptions.

12. The method of claim 10 or 11 wherein the increased electrical pathway formed by the one or more interruptions increases the resistance through the ceramic igniter.

13. The method of claim 10 or 11 wherein the step of disposing a surface pattern comprises forming one or more grooves in the surface of the first zone, whereby the increased electrical pathway extends on the at lease one surface and around the one or more grooves.

14. The method of claim 10 or 11 wherein the step of disposing a surface pattern comprises disposing one or more protrusions in the surface of the first zone, whereby the increased electrical pathway extends on the at lease one surface and around the one or more protrusions.

15. A method for modifying the length of the electrical pathway at least one region of a ceramic igniter comprising:
forming the ceramic igniter and densifying the ceramic igniter, wherein the densified ceramic igniter comprises at least one first zone of material having a first resistivity and a burn-out material disposed within the first zone, wherein the igniter has an electrical pathway in the first zone;
firing the densified ceramic igniter such that the burn-out material bums to leave one or more interruptions in the electrical pathway to thereby form an increased electrical pathway on the at least one surface and around the one or more interruptions.
